(19) United States
(12) Patent Application Publication
(10) Pub. No.: US 2003/0043759 A1
(43) Pub. Date: Mar. 6, 2003

(54) LC filter circuit, laminated LC composite component, multiplexer, and radio communication device

(75) Inventor: Naoto Yamaguchi, Shiga-ken (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/234,116

(22) Filed: Sep. 5, 2002

(30) Foreign Application Priority Data
Sep. 6, 2001 (JP) 2001-270150
Jul. 19, 2002 (JP) 2002-211557

(51) Int. Cl. H04B 3/20; H04B 7/00

(52) U.S. Cl. 370/290; 370/277

(57) ABSTRACT

A laminated LC filter includes inductors of a low-pass filter and an inductor of a trap circuit, which are disposed in different layers in the lamination direction of the insulator sheets. Inductor via-holes are connected to each other in the lamination direction of the insulator sheets to define columnar inductors. The inductor via-holes are electrically connected in series with coil-shaped conductor patterns to define inductors, respectively. The others of the inductor via-holes are electrically connected in series with a coil-shaped conductor pattern to define an inductor. Moreover, an inductor via-hole singly defines a columnar inductor.

### BACKGROUND OF THE INVENTION

1. Field of the Invention

The present invention relates to an LC filter circuit for use in, e.g., mobile communication devices such as portable telephones or other such devices and to a laminated LC composite component such as a laminated LC filter or other such component, a multiplexer, and a radio communication device.

2. Description of the Related Art

As the above-described type laminated LC composite component, a laminated LC filter described in Japanese Unexamined Patent Application Publication No. 2001-156569 is known. FIG. 7 is a cross-sectional view of a laminated LC filter 81. FIG. 8 is an electrically equivalent circuit diagram of the laminated LC filter 81.

A laminate 110 is formed by laminating a plurality of insulator sheets and integrally firing the insulator sheets An input terminal 111 and an output terminal 112 are disposed on the end surfaces on the right and left sides of the laminate 110. Ground terminals G1 and G2 (not shown in FIG. 7) are disposed on the surfaces on the front and backsides as viewed in FIG. 7 of the laminate 112. An input lead-out pattern 108 is connected to the input terminal 111. An output lead-out pattern 109 is connected to the output terminal 112. Shield patterns 105 and 106 are connected to the ground terminals G1 and G2.

Inductor via-holes 90a to 90d, 91a to 91d, and 92a to 92d, capacitor patterns 93 to 95, frequency-conditioning capacitor patterns 96 to 98, frequency-adjusting capacitor patterns 96 to 98, coupling capacitor patterns 99 to 101, a connecting pattern 102, shield patterns 105 and 106, and so forth are provided inside the laminate 110.

The inductor via-holes 90a to 90d, 91a to 91d, and 92a to 92d are connected to each other in the lamination direction of the insulator sheets to define columnar inductors L1, L2, and L3, respectively. The axial directions of the inductors L1 to L3 are substantially perpendicular to the surface of the insulator sheets. The respective ends of the inductors L1 to L3 (via-holes 90d, 91d, and 92d) are connected to the connecting pattern 102 for short-circuiting.

The frequency-adjusting capacitor patterns 96, 97, and 98 are opposed to the shield pattern 105 via the insulator sheet, whereby capacitors C1, C2, and C3 are provided. The frequency-adjusting capacitor pattern 96 is connected directly to the end (via-hole 90a) of the inductor L1. The inductor L1 and capacitor Cl define an LC resonator Q1. The frequency-adjusting capacitor pattern 97 is connected directly to the end (via-hole 91a) of the inductor L2. The inductor L2 and the capacitor C2 define an LC resonator Q2. The frequency-adjusting capacitor pattern 98 is connected directly to the end (via-hole 92a) of the inductor L3. The inductor L3 and the capacitor C3 define an LC resonator Q3.

The connecting pattern 102 is opposed to the shield pattern 106 with an insulator sheet being interposed between them, whereby a common capacitor Cd is provided. Thereby, the short-circuiting sides of the inductors L1 to L3 are common-line-coupled to each other via the connecting pattern 102 and, moreover, grounded via the common capacitor Cd.

The capacitor patterns 93, 94, and 95 are connected directly to the via-holes 90c, 91c, and 92c which constitute the inductors L1, L2, and L3, respectively. Moreover, the capacitor patterns 93 and 95 are connected to the input lead-out pattern 108 and the output lead-out pattern 109, respectively.

The capacitor patterns 93 and 94 are opposed to the coupling capacitor pattern 99 via an insulator sheet to define a coupling capacitor Cs1 for coupling the LC resonator Q1 and Q2. The capacitor patterns 94 and 95 are opposed to the coupling capacitor pattern 100 via an insulator sheet to define a coupling capacitor Cs2 for coupling the LC resonators Q2 and Q3 to each other. The coupling capacitor pattern 101 is opposed to the input-side LC capacitor pattern 93, the capacitor pattern 94, and the output-side capacitor pattern 95, whereby a coupling capacitor Cs3 for coupling the input-side LC resonator Q1 to the output-side LC resonator Q3 is provided. The position of the attenuation pole can be adjusted by changing the electrostatic capacity of the coupling capacitor Cs3. The resonators Q1 to Q3 are electrically connected to each other via the coupling capacitors Cs1 to Cs3, whereby a Chebyshev's type three-stage filter is provided.

In the laminated LC filter 81, the attenuation pole positioned nearest to the center frequency on the high frequency side thereof is designed by adjusting the electrostatic capacity of the coupling capacitor Cs3. However, if the electrostatic capacity of the coupling capacitor Cs3 is changed, problems arise in that not only the position of the attenuation pole but also that of the center frequency band on the high frequency side thereof is simultaneously changed, and the center frequency is shifted. Moreover, the size of the component is increased due to the coupling capacitor Cs3 that must be provided therein.

In the laminated LC filter 81, the inductors L1 to L3 defined by the via-holes 90a to 90d, 91a to 91d, and 92a to 92d are provided in the same layer. The upper ends of the inductors L1 to L3 are connected to the frequency-adjusting capacitor patterns 96, 97, and 98 and grounded via the capacitors C1, C2, and C3. On the other hand, the lower ends of the inductors L1 to L3 are common-line-coupled to each other via the connecting pattern 102 and grounded via the common capacitor Cd.

Accordingly, if the height of the LC filter 81 is decreased to achieve size-reduction (decrease of the volume), the overall length of each of the inductors L1 to L3 is reduced. In some cases, a required inductance cannot be attained. Moreover, if the area is decreased for size-reduction purposes, the intervals between the via-holes 90a to 90d and the via-holes 91a to 91d, or the intervals between the via-holes 91a to 91d and the via-holes 92a to 92d are reduced. Thus, problems arise in that the mechanical strength of the LC filter 81 is deteriorated.

### SUMMARY OF THE INVENTION

In order to overcome the problems described above, preferred embodiments of the present invention provide a very small-sized LC filter circuit in which an attenuation pole can be designed without the center frequency band being varied. In addition, preferred embodiments of the present invention provide a very small-sized laminated LC composite component which has a high mechanical strength without the inductance being reduced, and a multiplexer, and a radio communication device including such a very small-sized laminated LC composite component.

According to a preferred embodiment of the present invention, an LC filter circuit includes a plurality of terminals including an input terminal, an output terminal and a ground terminal, a low-pass filter circuit having an inductor and a capacitor and electrically connected between the input terminal and the output terminal, and a trap circuit having one end thereof electrically connected to the low-pass filter circuit and the other end thereof electrically connected to the ground terminal.

Preferably, the low-pass filter circuit includes at least two inductors electrically connected in series between the input terminal and the output terminal, and at least two capacitors electrically connected in parallel to the input terminal and the output terminal, respectively, and having one ends thereof electrically connected to the ground terminal. The trap circuit includes an LC series circuit having an inductor and a capacitor which is shunt-connected between the input terminal and the output terminal, and has one end thereof electrically connected to the ground terminal. Moreover, a capacitor for band-adjustment is connected between the input terminal and the connecting point of the inductor and the capacitor included in the LC series circuit, and a capacitor for band-adjustment is connected between the output terminal and the connecting point. The inductor of the trap circuit is electrically connected to the connecting point of the adjacent inductors included in the low-pass filter circuit.

With the above-described configuration, the attenuation pole nearest to the center frequency on the high frequency side can be designed by adjusting the capacity of the trap circuit, more specifically, the static capacitance of the capacitor contained in the LC series circuit.

Moreover, according to preferred embodiments of the present invention, a laminated LC composite component includes a laminate having a plurality of insulative layers laminated together, a filter circuit including an inductor and a capacitor, and a trap circuit including an inductor and a capacitor, the inductor of the filter circuit including a first inductor via-hole extending in the lamination direction of the insulative layers, the inductor of the trap circuit being defined by second via-hole extending in the lamination direction of the insulative layers, and the inductor of the filter circuit (that is, the first inductor via-hole) and the inductor of the trap circuit (that is, the second inductor via-hole) being disposed in different layers in the lamination direction of the insulative layers.

In the above-described configuration, the inductors of the filter circuit and the inductor of the trap circuit are disposed in different layers in the lamination direction of the laminate. Therefore, the size of the laminate is greatly reduced. In addition, when a plurality of inductor via-holes are provided, the intervals between via-holes formed in the same layer can be very large. Moreover, the trap circuit having a high Q can be produced by forming the inductor of the trap circuit with the via-hole extending in the lamination direction of the insulative layers. Thus, the trap circuit having a sharp and large attenuation can be provided.

In the case in which the inductor of the filter circuit is provided with the first inductor via-hole and the coil-shaped conductor pattern disposed on the surface of the insulative layer, a portion of the inductor included in the filter circuit is defined by the coil-shaped conductor pattern. Therefore, the height of the inductor of the filter circuit is greatly decreased. Accordingly, when the inductor of the filter circuit and the inductor of the trap circuit are overlapped in the lamination direction of the laminate, the laminated LC composite component having a very small height can be provided compared to the laminated LC filter of the related art.

Preferably, the second inductor via-hole is disposed on the upper side of a ground pattern disposed in the laminate, the first inductor via-hole is disposed on the upper side of the second inductor via-hole, and the coil-shaped conductor pattern is disposed on the upper side of the first inductor via-hole. Thus, the distance between the inductor of the filter circuit and the ground pattern is increased, so that the phenomenon in which a signal transmitted through the input terminal is fed into the ground pattern can be suppressed.

Moreover, the grounding state of the ground pattern is even more improved, so that the static capacity can be secured with high stability, and the position of the attenuation pole caused by the trap circuit can be stabilized, since the respective capacitors of the filter circuit and the trap circuit are preferably disposed on the underside of the inductor of the trap circuit.

Also, according to other preferred embodiments of the present invention, a multiplexer and a radio communication device each includes a laminated LC composite component according to preferred embodiments of the present invention described above. Thus, the multiplexer and the radio communication device having a greatly reduced size and a very small height can be provided.

Other features, elements, characteristics and advantages of the present invention will become more apparent from the following detailed description of preferred embodiments thereof with reference to the attached drawings.

### BRIEF DESCRIPTION OF THE DRAWINGS

FIG. 1 is an exploded perspective view of a laminated LC filter according to a preferred embodiment of the present invention;

FIG. 2 is a perspective view showing the appearance of the laminated LC filter of FIG. 1;

FIG. 3 is a schematic cross-sectional view of the laminated LC filter of FIG. 2;

FIG. 4 is an electrically equivalent circuit diagram of the laminated LC filter of FIG. 2;

FIG. 5 is a graph showing the transmission and reflection characteristics of the laminated LC filter of FIG. 2;

FIG. 6 is an electrical circuit block diagram showing an example of the RF portion of a radio communication device of a preferred embodiment of the present invention;

FIG. 7 is a schematic cross-sectional view of a laminated LC filter of the related art; and

FIG. 8 is an electrically equivalent circuit diagram of the laminated LC filter of FIG. 7.

### DETAILED DESCRIPTION OF PREFERRED EMBODIMENTS

Hereinafter, preferred embodiments of the LC filter circuit, the laminated LC composite component, the multiplexer, and the radio communication device of the present invention will be described with reference to the accompanying drawings.

Hereinafter, the LC filter circuit and the laminated LC composite component in accordance with one of the preferred embodiments of the present invention will be described making reference to a chip-type laminated LC filter.

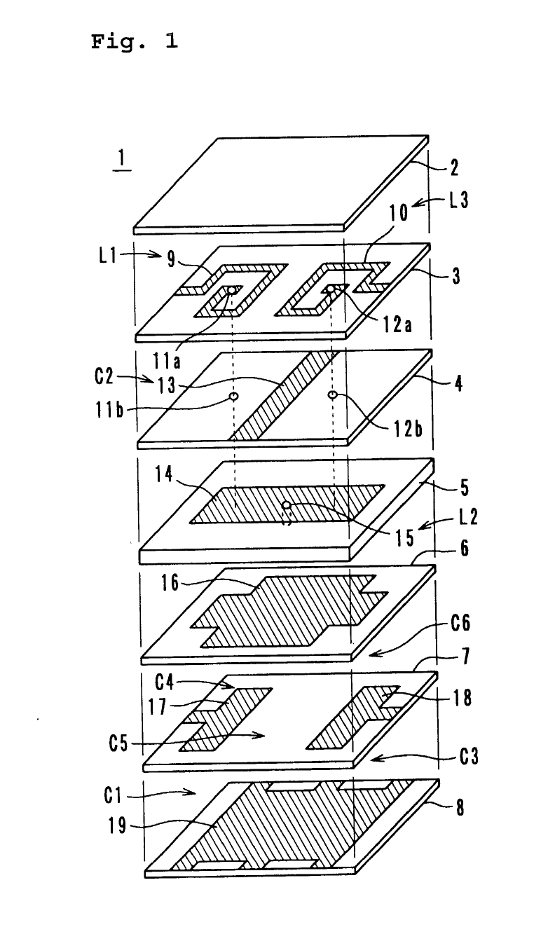

As shown in FIG. 1, a laminated LC filter 1, as an example of the laminated LC composite component, preferably includes insulator sheets 2 to 8 or other suitable sheets, which are provided with coil-shaped conductor patterns 9 and 10, via-holes 11a, 11b, 12a, 12b, and 15, capacitor electrode patterns 13 to 18, and a ground electrode pattern 19, respectively. The insulator sheets 2 to 8 are produced preferably by mixing dielectric powder or magnetic powder with a binder or other suitable material, and forming the mixture into a sheet. The thickness of the sheet 5 having the via-hole 15 is preferably larger compared to the other sheets. For this purpose, the thickness of the sheet 5 may be attained by laminating a plurality of sheets each having the same thickness as that of a sheet 2, or by using one sheet having a large thickness.

The coil-shaped conductor patterns 9, 10, and the capacitor electrode pattern 13 to 19 are preferably made of Ag, Pd, Cu, Ni, Au, Ag-Pd or other suitable material and are preferably formed by sputtering, vapor deposition, screen printing, photolithography, or other suitable process. To form the via-holes 11a, 11b, 12a, 12b, and 15, the insulator sheets 3 to 5 are perforated via mold-punching, laser, or other suitable process, and a conductor material such as Ag, Pd, Cu, Ni, Au, Ag-Pd, or other suitable material is filled into the holes.

The coil-shaped conductor patterns 9 and 10 have a convoluted shape and are disposed on the surface of the sheet 3, respectively. The coil-shaped conductor pattern 9 is disposed substantially on the left-side half of the surface of the sheet 3. The lead-out portion of the pattern 9 is exposed onto the left side of the sheet 3. The coil-shaped conductor pattern 10 is disposed substantially on the right-side half of the sheet 3. The lead-out portion is exposed onto the right side of the sheet 3.

The via-holes 11a and 11b, 12a and 12b are respectively connected in the lamination direction of the insulator sheets 2 to 8 to form columnar first inductor via-holes 11 and 12. Then, the first inductor via-holes extends along the lamination direction of the insulator sheets 2 to 8, and the axial directions of the inductor via-holes are substantially perpendicular to the surfaces of the sheets 2 to 8.

The first inductor via-hole 11 including via-holes 11a and 11b is connected in series with the coil-shaped conductor pattern 9 to define the inductor L1 having a desired inductance. The other inductor via-hole 12 including via-holes 12a and 12b is electrically connected in series with the coil-shaped conductor pattern 10 to define the inductor L3 having a desired inductance. Moreover, the second inductor via-hole 15 alone defines a columnar inductor L2 having a desired inductance.

First ends of the respective inductors L1 to L3 (that is, via-holes 11b, 15, and 12b) are connected to the connection point 14, which is equivalent to capacitor electrode pattern 14, and are common-line coupled. The second end of the inductor L2 is connected to the capacitor electrode pattern 16.

The lead-out portions of the capacitor electrode patterns 17 and 18 disposed in the right and left areas of the surface of the insulator sheet 7 are exposed at the left and right sides of the sheet 7, respectively. These capacitor electrode patterns 17 and 18 are opposed to the ground pattern 19 with the insulator sheet 7 being interposed between them, whereby capacitors C1 and C3 are provided. Moreover, the capacitor electrode patterns 17 and 18 are opposed to the capacitor electrode pattern 16 with the insulator sheet 6 being interposed between them, whereby capacitors C4 and C6 are provided.

The lead-out portions on both ends of the capacitor electrode pattern 13 disposed in the approximate center of the insulator sheet 4 are exposed at the front edge and the back edge as viewed in the drawing of the sheet 4. The capacitor electrode pattern 13 is opposed to the capacitor electrode pattern 14 with the insulator sheet 4 being interposed between them, whereby a capacitor C2 is provided. Furthermore, the central portion of the capacitor electrode pattern 16 is opposed to the central portion of the ground electrode pattern 19 with the insulator sheets 6 and 7 being interposed between them, whereby a capacitor C5 is provided.

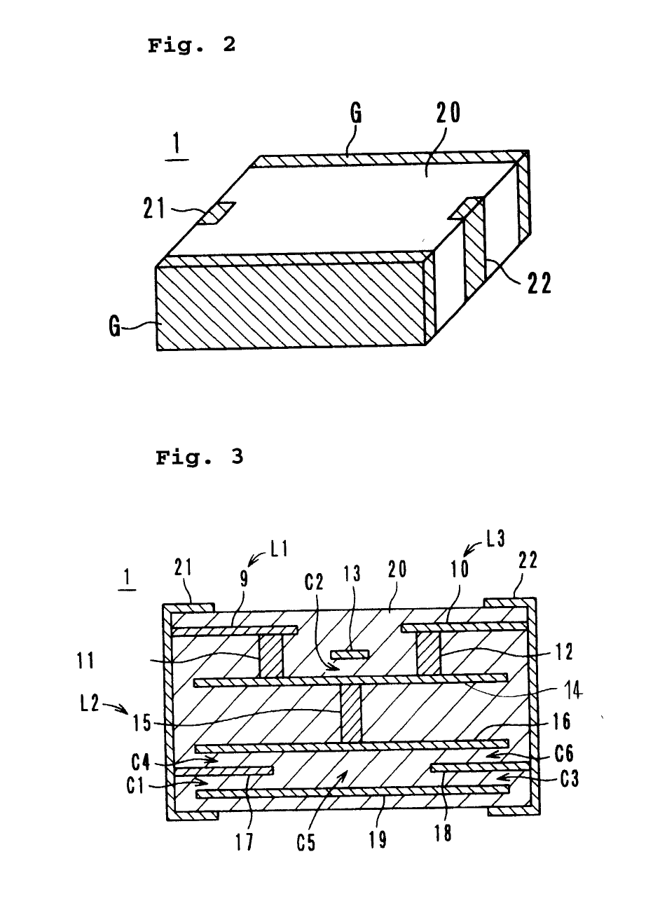

The insulator sheets 2 to 8 are laminated and fired to be integrated. Thus, a laminate 20 shown in FIGS. 2 and 3 is obtained. An input terminal 21 and an output terminal 22 are disposed on the end surfaces on the right and left sides of the laminate 20, respectively. Ground terminals G are disposed on the front surface and the back surface of the laminate 20, respectively. These terminals 21, 22, and G are formed preferably by sputtering, vapor deposition, coating, screen-printing, or other suitable process, and are made of a material such as Ag-Pd, Ag, Pd, Cu, a Cu alloy, or other suitable material.

One end of the inductor L1 (specifically, the-lead-out portion of the coil-shaped conductor pattern 9) and the lead-out portion of the capacitor electrode pattern 17 are electrically connected to the input terminal 21. One end of the inductor L3 (specifically, the lead-out portion of the coil-shaped conductor pattern 10) and the lead-out portion of the capacitor electrode pattern 18 are electrically connected to the output terminal 22. The capacitor electrode pattern 13 and the ground electrode pattern 19 are electrically connected to the ground terminal G.

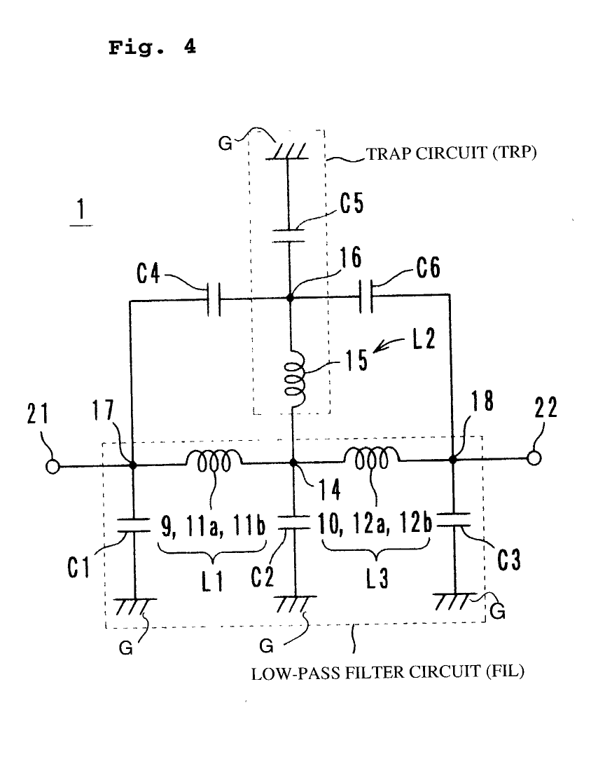

FIG. 4 is an electrically equivalent circuit diagram of the LC filter circuit 1′, which is equivalent to laminated LC filter 1 produced in such a manner as described above.

The capacitors C1 to C3 and the inductors L1 and L3 constitute a low-pass filter circuit FIL. The capacitors C4 to C6 and the inductor L2 constitute a trap circuit TRP.

In particular, the low-pass filter circuit FIL includes the two inductors L1 and L3 connected in series with each other between the input and output terminals 21 and 22, and the capacitors C1 to C3 electrically connected in parallel to the input terminal 21 and the output terminal 22, respectively. The trap circuit TRP is shunt-connected between the input and output terminals 21 and 22, and includes a series circuit of the inductor L2 and the capacitor C5, one end of the series circuit being electrically connected to the ground terminal G. Moreover, the capacitor C4 for band-adjustment is connected between the input terminal 21 and the connecting point 16 of the inductor L2 and the capacitor C5 contained in the series circuit. Moreover, the capacitor C6 for band-adjustment is connected between the output terminal 22 and the connecting point 16 of the inductor L2 and the capacitor C5 included in the LC series circuit. The inductor L2 of the trap circuit TRP is electrically connected to the connecting point of the adjacent inductors L1 and L3 included in the low-pass filter circuit.

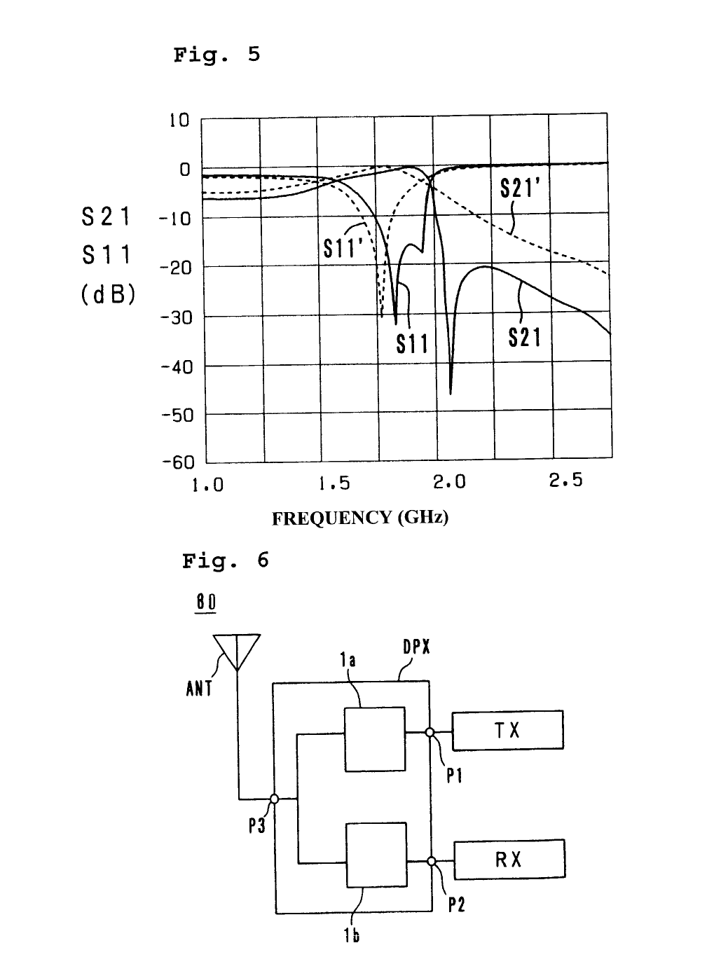

FIG. 5 graphically illustrates the transmission characteristic S21 and the reflection characteristic S11 of the LC filter 1 (see the solid lines). For comparison, the transmission characteristic S21′ and the reflection characteristic S11′ of the low-pass filter circuit that only includes the capacitors C1 to C3 and the inductors L1 and L3 are also shown in FIG. 5.

In the laminated LC filter 1 configured as described above, the attenuation pole nearest to the center frequency on the high frequency side is designed by adjusting the electrostatic capacity of the capacitor C5. From the standpoint of the circuit configuration, the capacitor C5 and the inductor L2 of the trap circuit are independent of the capacitors C1 to C3 and the inductors L1 and L3. Therefore, when the electrostatic capacity of the capacitor C5 is changed for design of the attenuation pole, the center frequency band is not changed. In this manner, the design of the attenuation pole can be carried out without the center frequency band being changed. Moreover, the coupling capacitor Cs3, which is included in the laminated LC filter 81 of the related art becomes unnecessary, so that the number of parts can be correspondingly decreased. The size of the laminated LC filter can be reduced, and the manufacturing cost can be saved.

Moreover, as shown in FIG. 8, in the LC filter 81 of the related art, the input and output terminals 111 and 112 are electrically connected to the intermediate points of the inductors L1 and L3, respectively. On the other hand, in the LC filter 1 of the first preferred embodiment of the present invention, as shown in FIG. 4, the input terminal 21 is electrically connected to the connecting point of the inductor L1 and the capacitor C1, and the output terminal 22 is electrically connected to the connecting point of the inductor L3 and the capacitor C3. Accordingly, the input-output impedance of the low-pass filter circuit can be increased.

Moreover, in the lamination direction of the insulator sheets 2 to 8, the inductors L1 and L3 of the low-pass filter circuit and the inductor L2 of the trap circuit are disposed in different layers, respectively, so that the magnetic coupling between the inductors L1 and L3 and the inductor L2 is minimized. Therefore, a signal transmitted in the low-pass filter circuit is prevented from being fed into the inductor L2 of the trap circuit. Thus, the low-pass filter circuit and the trap circuit can be designed independently of each other. The design can be easily achieved. Moreover, the magnetic coupling between the inductors L1 and L3 and the inductor L2 is minimized. Therefore, a signal transmitted in the low-pass filter circuit is prevented from being fed into the inductor L2 via the trap circuit, and the input impedance is increased. For this reason, the input reflection loss can be reduced.

Furthermore, the inductors L1 and L3 of the low-pass filter circuit and the inductor L2 of the trap circuit are disposed in different layers, respectively. Thus, the area can be reduced. Moreover, the interval between the inductor via-holes 11a and 12a formed in the same insulator sheet 3 and the interval between the inductor via-holes 11b and 12b formed in the same insulator sheet 4 can be relatively large, since the number of inductor via-holes formed in the same layer is decreased. As a result, the laminated LC filter 1 having a small area and a high mechanical strength can be provided.

Furthermore, since the inductor L2 of the trap circuit is formed with the inductor via-hole 15 provided in the lamination direction of the insulator sheets 2 to 8, the main surfaces of the capacitor patterns 14 and 16 or the like are substantially parallel to magnetic force lines caused by the inductor L2. Accordingly, the eddy current loss of the electrodes such as the capacitor patterns 14 and 16, generated by the magnetic force lines of the inductor L2 is minimized so as to be very small. Thus, reduction of the Q is prevented and minimized. Moreover, since the cross-sectional area of the inductor L2 can be increased, the Q is greatly improved. As a result, the trap circuit having a high Q can be provided. Thus, the trap circuit of which the attenuation is sharp and large can be provided.

A portion of the inductors L1 and L3 contained in the low-pass filter circuit are produced with the conductor patterns 9 and 10 disposed on the surface of the insulator sheet 3. Therefore, the height of the inductors L1 or L3 is substantially equal to the total length of the inductor via-holes 11a and 11b or the total length of the via-holes 12a and 12b. That is, the heights of the inductor L1 and L3 can be reduced.

Moreover, since the convoluted coil-shaped conductor patterns 9 and 10 can be formed on the surface of the insulator sheet 3, the inductors L1 and L3 having a large size can be obtained. The inductors L1 and L3 of the low-pass filter circuit are required to have large inductances, while a relatively small inductance is sufficient for the inductor L2 of the trap circuit. For this reason, the length of the inductor L2 of the trap circuit can be reduced by adoption of the structure in which the inductors L1 and L3 and the inductor L2 are disposed in different layers. It should be noted that the center frequency of the trap circuit is in inverse proportion to (LC)^{½}. Accordingly, when the inductance of the inductor L2 is reduced, it is required to increase the electrostatic capacitance of the capacitor C5 in order to secure the same center frequency. However, the electrostatic capacitance of the capacitor C5 can be easily increased without problems by reducing the thicknesses of the dielectric sheets 6 and 7.

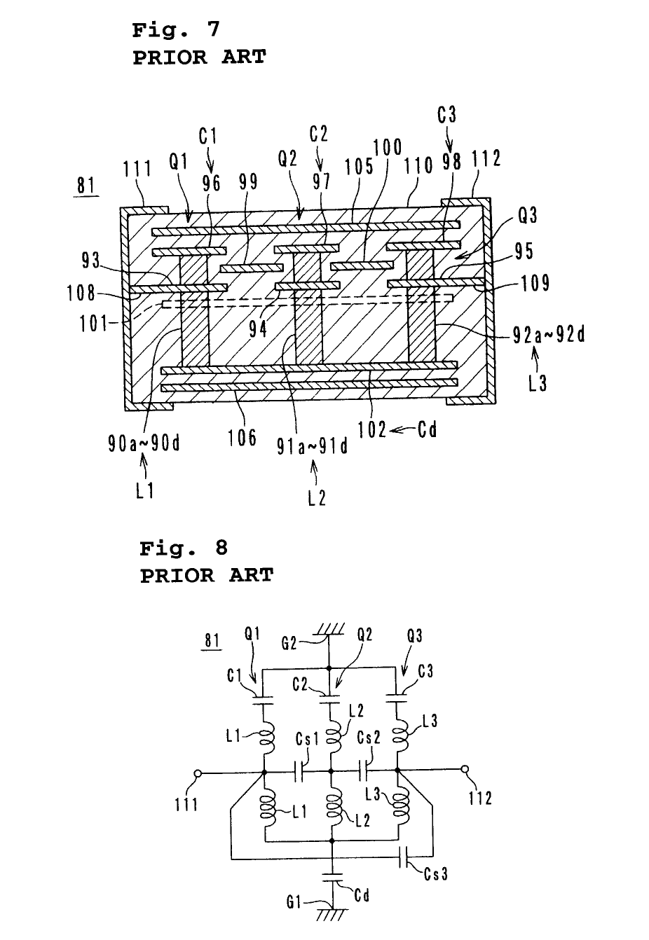

Accordingly, the laminated LC filter 1 having a small height can be obtained by overlapping the inductors L1 and L3 and the inductor L2 to each other in the lamination direction of the laminate 20, compared to a laminated LC filter of the related art. Specifically, regarding the laminated LC filter 81 of the related art shown in FIGS. 7 and 8, the size is 3.2×2.5×1.8 mm(=14.4 mm³). According to an example of a preferred embodiment of the present invention, the size of the laminated LC filter can be reduced to approximately 2.0×1.25×1.1 mm (=2.75 mm³). That is, the volume can be reduced to one fifth of that of the related art filter 81.

Furthermore, in the first preferred embodiment of the present invention, in the lamination direction of the insulator sheets 2 to 8, the inductor L2 of the trap circuit is disposed above the ground pattern 19 provided in the laminate 20, and the inductors L1 and L3 of the low-pass filter circuit are disposed above the inductor L2. In the inductors L1 and L3, the coil-shaped conductor patterns 9 and 10 are disposed on the inductor via-holes 11a, 11b, 12a, and 12b, respectively. Thereby, the distance between the inductors L1 and L3 of the low-pass filter circuit and the ground pattern 19 is increased. Thus, the phenomenon in which a signal transmitted through the input terminal 21 is fed directly into the ground pattern 19 is reliably prevented. As a result, the input reflection loss can be more reduced.

Moreover, since the ground pattern 19 is disposed near the surface layer on the bottom side of the laminate 20, an equivalent series inductance (residual inductance) to be generated between the ground pattern 19 and the ground can is minimized. Thus, the grounding state of the ground pattern 19 is even more improved. The electrical characteristics of the capacitors C1, C3, and C5 provided on the grounding side of the low-pass filter circuit and the trap circuit are stabilized. Thereby, the position of the attenuation pole formed by the trap circuit becomes stable.

Preferably, the electrode-distance between the capacitor patterns 13 and 14 is reduced to be about 50 μm or smaller. Thereby, the capacitor C2 can securely perform its function. If the electrode-distance between the capacitor patterns 13 and 14 becomes large, that is, the capacitor 14 is positioned to be excessively distant from the capacitor pattern 13. A magnetic field generated by the inductor via-holes 11a to 12b interacts with the capacitor pattern 13, which may cause the characteristics of the inductors L1 and L2 to be varied.

The LC filter circuit and the laminated LC composite component of the present invention are not limited to the above-described preferred embodiments, and various changes and modifications may be made in the invention without departing from the spirit and scope thereof. The filter circuit of the laminated LC composite component may be a band-pass filter circuit, a high-pass filter circuit or other suitable circuit, in addition to the low-pass filter circuit. Moreover, examples of the composite component include component each including a plurality of filters in one laminate such as a duplexer, a triplexer, a multiplexer, and so forth which are formed by combining band-pass filters with each other.

As shown in FIG. 6, a duplexer DPX including two laminated LC filters described above, and a radio communication device 80 including the duplexer DPX are exemplified. The duplexer DPX is preferably formed by electrically connecting the laminated LC filters 1 (1a, 1b), and is provided with three ports P1, P2, and P3. The port P1 of the duplexer DPX is disposed in one end of the laminated LC filter 1a, and is connected-to a transmission unit TX. The port P2 of the duplexer DPX is disposed in one end of the laminated LC filter 1b, and is connected to a reception unit RX. Moreover, the port P3 of the duplexer DPX is disposed in the other ends of the laminated LC filter 1a and the laminated LC filter 1b, and is connected to an antenna ANT. Thus, the duplexer can be formed by configuring the laminated LC filters as described above. Accordingly, the duplxer of which the area is small, the mechanical strength is high, the size is small, and the height is reduced without the inductance being decreased can be obtained. Similarly, the laminated LC filter 1 may be used in a multiplexer such as a triplexer which corresponds to three frequencies.

Moreover, in the above-described preferred embodiments, the insulator sheets having the conductor patterns and the via-holes formed therein, respectively, are laminated, and then fired to be integrated. This is not restrictive. The insulator sheets may be previously fired and used. Also, the LC filter may be produced according to a method described below. Insulative layers are formed with insulating material paste by printing or other suitable process, and electroconductive material paste is applied onto the surfaces of the insulative layers, whereby conductor patterns and via-holes are provided. Thereafter, insulating material paste is applied thereon to define an insulative layer. The coating is sequentially applied thereon in a similar manner to produce an LC filter having a lamination structure.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. An LC filter circuit comprising:
a plurality of terminals including an input terminal, an output terminal and a ground terminal;
a low-pass filter circuit including an inductor and a capacitor and electrically connected between the input terminal and the output terminal; and
a trap circuit having a first end thereof electrically connected to the low-pass filter circuit and a second end thereof electrically connected to the ground terminal.

2. The LC filter circuit according to claim 1, wherein the low-pass filter circuit includes at least two inductors electrically connected in series between the input terminal and the output terminal, and at least two capacitors electrically connected in parallel to the input terminal and the output terminal, respectively, and having first ends thereof electrically connected to the ground terminal.

3. The LC filter circuit according to claim 2, wherein the trap circuit includes an LC series circuit having an inductor and a capacitor which is shunt-connected between the input terminal and the output terminal, and has a first end thereof electrically connected to the ground terminal.

4. The LC filter circuit according to claim 3, wherein a capacitor is connected between the input terminal and the connecting point which is provided between the inductor and the capacitor in the trap circuit, and a capacitor is connected between the output terminal and the connecting point, and the inductor of the trap circuit is electrically connected to the connecting point which is provided between the adjacent inductors included in the low-pass filter circuit.

5. The LC filter circuit according to claim 1, wherein LC filter circuit is one of a low-pass filter circuit, a band-pass filter circuit, and a high-pass filter circuit.

6. A multiplexer including the LC filter circuit according to claim 1.

7. A radio communication device including at least one LC filter circuit according to claim 1.

8. A radio communication device including at least one multiplexer according to claim 6.

9. A laminated LC composite component comprising:
a laminate including a plurality of insulative layers laminated together in a lamination direction;
a filter circuit including an inductor and a capacitor; and
a trap circuit including an inductor and a capacitor; and
the inductor of the filter circuit including a first inductor via-hole extending-in the lamination-direction of the insulative layers, the inductor of the trap circuit including a second inductor via-hole extending in the lamination direction of the insulative layers; and
the first inductor via-hole and the second inductor via-hole being disposed in different layers in the lamination direction of the insulative layers.

10. The laminated LC composite component according to claim 9, wherein a ground pattern is disposed in the laminate, the second inductor via-hole is disposed on the upper side of the ground pattern, and the first inductor via-hole is disposed on the upper side of the second inductor via-hole.

11. The laminated LC composite component according to claim 10, wherein a coil-shaped conductor pattern is disposed on the upper side of the first inductor via-hole in the lamination direction of the insulative layers, and the inductor of the filter circuit is defined by the first inductor via-hole and the coil-shaped conductor pattern.

12. The laminated LC composite component according to claim 11, wherein at least one capacitor selected from the group consisting of the capacitor of the filter circuit and the capacitor of the trap circuit is disposed between a capacitor pattern and the ground pattern.

13. The laminated LC composite component according to claim 9, wherein the filter circuit is a low-pass filter circuit.

14. The laminated LC composite component according to claim 9, wherein filter circuit is one of a low-pass filter circuit, a band-pass filter circuit, and a high-pass filter circuit.

15. A multiplexer including the laminated LC composite component according to claim 9.

16. A radio communication device including at least one laminated LC composite component according to claim 9.

17. A radio communication device including at least one multiplexer defined in claim 15.
